(19) United States
(12) Patent Application Publication
(10) Pub. No.: US 2020/0069980 A1
(43) Pub. Date: Mar. 5, 2020

(54) FIREFIGHTER HOOD

(71) Applicant: PGI, Inc., Green Lake, WI (US)

(72) Inventor: James A. Sonntag, Green Lake, WI (US)

(73) Assignee: PGI, Inc., Green Lake, WI (US)

(21) Appl. No.: 16/559,404

(22) Filed: Sep. 3, 2019

Related U.S. Application Data
(60) Provisional application No. 62/725,693, filed on Aug. 31, 2018.

(51) Int. Cl. A62B 17/04; A41D 31/08

(52) U.S. Cl. CPC A62B 17/04; A41D 31/085

(57) ABSTRACT

An improved firefighter's hood that is comfortable but also provides thermal protection as well as improved barrier properties to fine and superfine particulates encountered in fire and other emergencies.

### BACKGROUND OF THE INVENTION

### 1) Field of the Invention

The present invention relates to an improved firefighter's hood that is comfortable but also provides thermal protection as well as improved barrier properties to fine and superfine particulates encountered in fire and other emergencies

### 2) Description of Related Art

The smoke released by any type of fire (forest, brush, crop, structure, tires, waste or wood burning) is a mixture of particles and chemicals produced by incomplete burning of carbon-containing materials. All smoke contains carbon monoxide, carbon dioxide and particulate matter (PM or soot). Smoke can contain many different chemicals, including aldehydes, acid gases, sulfur dioxide, nitrogen oxides, polycyclic aromatic hydrocarbons (PAHs), benzene, toluene, styrene, metals and dioxins. Further, there is a minimum of nine Group 1 carcinogens in all fire smoke. The type and amount of particles and chemicals in smoke varies depending on what is burning, how much oxygen is available, and the burn temperature. All smoke is hazardous and potentially lethal at high enough concentrations.

Of all the protective elements worn as part of the firefighter's ensemble, perhaps the least appreciated item is the protective hood. Over the past three decades, hoods have become a standard part of the ensemble. The hood covers the exposed areas of the body that are not covered by the coat collar, Self-Contained Breathing Apparatus (SCBA) face piece or helmet. As such, the hood is considered to be an interface item somewhat like the wristlets of coats which help connect coat sleeves and gloves. Interface areas are for the critical gaps in the ensemble where burns can readily occur if not properly protected. Therefore, the correct selection and use of the protective hood is essential for completing the envelope of protection in this critical head-neck interface area. The majority of current hoods in the marketplace comprise a sock configuration shaped much like a ski mask, having a face opening that fits over the SCBA face piece. Hoods have bibs that extend down both sides and the front and back so that the hood remains tucked in under the collar of the coat.

Protective hoods are the most vulnerable area of the firefighter's ensemble. Hoods lack any type of barrier characteristics to keep out superfine particles that absorb a variety of hazardous chemicals, including carcinogens, during firefighting events. Further, National Institute for Occupational Safety and Health (NIOSH) studies and other research show carcinogen buildup on firefighters' skin, particularly on the neck and areas unprotected by the SCBA face piece. Further, skin around a person's jaw line absorbs chemicals easily. This has led to the conclusion that current hoods have little effectiveness in keeping out soot.

Standard firefighter hoods are commonly disparaged as “cancer sponges” because they are made of a material similar to terry cloth, which when wet can absorb toxins through direct contact with a firefighter's head, jaw, and neck. This allows dangerous carcinogens to easily enter the bloodstream through the thinnest skin on a firefighter's body and puts them at greater risk of unnecessary exposures that can lead to developing cancer.

Rare and aggressive forms of cancer in fire service starts with constant exposure to carcinogens that are absorbed through the skin. The thinnest skin on your body is in the neck and jaw area. The majority of hoods currently worn by fire service professionals do not protect this area. The skin is the largest organ of the human body and is highly absorptive, especially in the face, neck, and throat areas. For every 5-degree increase in skin temperature the skin absorption increases by up to 400 percent. Without particulate barrier hoods, firefighters are not only exposed to dangerous toxins and chemicals daily but are exposed to them at a higher absorption rate through the skin.

Accordingly, it is an object of the present invention to provide an improved firefighter's hood that is comfortable but also provides thermal protection as well as improved barrier properties to fine and superfine particulates encountered in fire and other emergencies.

### SUMMARY OF THE INVENTION

The above objectives are accomplished according to the present invention by providing in a first embodiment, an improved firefighter's hood. The hood may include a facial opening, an expanding panel running from the facial opening to a bottom bib of the fire-fighter's hood, wherein the expending panel lacks a center seam. The hood may be comprised of at least two layers across defined areas of the hood outer shell. The hood may also include an outermost layer comprising a first flame resistant fabric, an inner layer comprising a polyimide nanofiber nonwoven particulate barrier membrane. The outermost layer may include 30-55% of at least one meta aramid, 10-20% of at least one para-aramid, 5-15% high tenacity nylon, and 0-10% anti-static compound. Further, the hood may include a bottom layer comprising a second flame resistant fabric and, along with the outermost layer, substantially encloses the polyimide nanofiber nonwoven particulate barrier membrane at defined areas of the hood outer shell. Further still, the first flame resistant fabric and the second flame resistant fabric comprise different flame resistant fabrics. Again yet, the hood includes a finish for reducing build up and releasing contaminates during laundering. Further again, laundering the fire-fighter's hood increases the firefighter hood's particulate resistance. Still yet, the hood outer shell comprises quilted and non-quilted sections. Yet still, the non-quilted sections lack the polyimide nanofiber nonwoven particulate barrier membrane. Further again, the quilted sections comprise a bottom layer comprising a second flame resistant fabric and the outermost substantially enclose the polyimide nanofiber nonwoven particulate barrier membrane. Still yet, the face opening has a percent elongation of 60-70% or greater. Still again further, the hood has 95%-98% particulate filtration efficiency for particulate ranging from 0.1 to 1.0 microns.

In an alternative embodiment, a method of forming an improved firefighter's hood is disclosed The method may include assembling an outer layer, an inner layer, and a bottom layer to one another to form a firefighter's hood, forming a facial opening, forming an expanding panel running from the facial opening to a bottom bib of the firefighter's hood, wherein the expending panel lacks a center seam, forming the outer layer to comprise a first flame resistant fabric, forming the inner layer to comprise a polyimide nanofiber nonwoven particulate barrier membrane; and forming the outer layer to include 30-55% of at least one meta aramid, 10-20% of at least one para-aramid, 5-15% high tenacity nylon; and 0-10% anti-static compound. Further, the bottom layer may be formed comprising a second flame resistant fabric and along with the outer layer substantially encloses the polyimide nanofiber nonwoven particulate barrier membrane. Again, the first flame resistant fabric and the second flame resistant fabric may comprise different flame resistant fabrics. Again still, the hood may include a finish for reducing build up and releasing contaminates during laundering. Further again, laundering the firefighter's hood increases the firefighter hood's particulate resistance. Still further yet, the outer surface of the firefighter's hood may comprise quilted and non-quilted sections. Yet again further, the non-quilted sections lack the polyimide nanofiber nonwoven particulate barrier membrane. Still yet again, the quilted sections may comprise a bottom layer comprising a second flame resistant fabric and the outermost substantially enclose the polyimide nanofiber nonwoven particulate barrier membrane. Still further, the face opening may be formed to have a percent elongation of at least 60-70%. Further yet, the method may include forming the firefighter's hood to have 95%-98% particulate filtration efficiency for particulate ranging from 0.1 to 1.0 microns.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows one embodiment of a layered fabric construct that may form a hood of the present disclosure.

FIG. 2 shows a photograph comparison of particulate exposure resulting from a hood employing a polyimide nanofiber nonwoven particulate barrier membrane layer compared to particulate exposure for a hood that lacks a polyimide nanofiber nonwoven particulate barrier membrane integrated into the hood.

FIG. 3A shows a front profile view of one embodiment of a firefighter's hood of the current disclosure.

FIG. 3B shows a side profile view of one embodiment of a firefighter's hood of the present disclosure

FIG. 3C shows a back view of one embodiment of a firefighter's hood of the pre-sent disclosure.

FIG. 4 shows Table 1, which provides various fabric performance specifications for a hood pursuant to one embodiment of the current disclosure.

FIG. 5 shows an alternative embodiment of a hood of the current disclosure that employs different quilting patterns across the surface of hood.

FIG. 6 shows a different view of FIG. 5.

FIGS. 7A and 7B show different views of a further embodiment of a hood of the current disclosure.

FIGS. 8A and 8B show different views of a further embodiment of a hood of the current disclosure.

FIGS. 9A and 9B show different views of a further embodiment of a hood of the current disclosure.

FIGS. 10A and 10B shows different views of a further embodiment of a hood of the current disclosure.

FIG. 11 shows a photograph of a portion of hood of the current disclosure back lit to show a hood in good condition as well as a hood having an internal structural integrity issues.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

In one embodiment, the current disclosure provides an improved contour firefighter hood that better fits the wearer's head. A fuller cut builds “ease” into the hood eliminating the skintight fit of typical hoods. The more generous cut also provides additional thermal protection. A hood of the current disclosure may incorporate a contoured “Sure Fit”, approximately 4 inch, but narrower or wider measurements are considered within the scope of this disclosure and hereby disclosed such as 2, 3, 5, 6, 7, 8, etc., wide panel running from the top of the face opening over the dome of the wearer's head, running approximately 10 inches, but shorter or longer measurements are considered within the scope of this disclosure and hereby disclosed, such as 7, 8, 9, 11, 12, 13, 14, 15, etc., rather than the traditional center seam of prior firefighting garments. The Sure Fit panel counters a hood of the present disclosure to the shape of the wearer's head for improved fit and comfort. Also, because the Sure Fit panel is located underneath a firefighting helmet suspension system it does not require particulate protection, which allows the panel to incorporate a much more breathable, air permeable, fabric to minimize heat stress on the wearer.

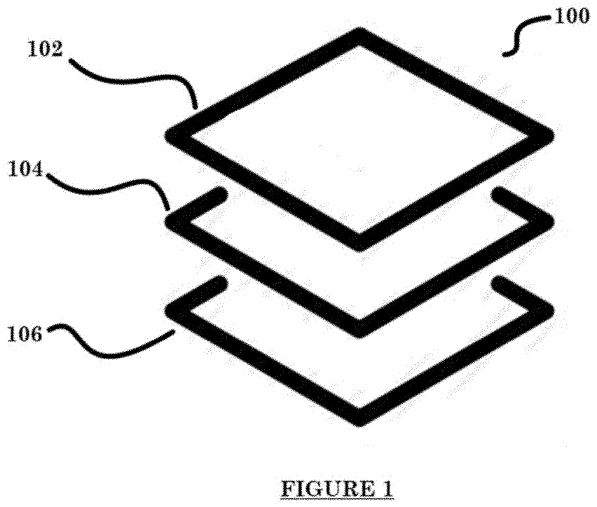

The largest contributor of particular contamination at a fire scene is carbon particles from incomplete combustion of organic substances, i.e., soot. The current exposure provides hoods that provide enhanced protection from contaminants at the face, jaw, neck and throat. The current disclosure provides multilayer protection, see FIG. 1, which shows one embodiment of a layered fabric construct 100 that may form a hood of the present disclosure. In one embodiment, outer layer 102 may comprise flame resistant fabric or FR fabric. In one embodiment, FR fabric may be comprised of at least one meta-aramid, which can be a blend of two or more meta-aramids having distinct crystallinities, at least one para-aramid, at least one aliphatic or semi-aromatic polyamide, and at least one anti-static compound. In a further embodiment, the FR fabric may comprise from 50-80% of at least one meta aramid fiber, 10-30% of at least one para-aramid fiber, 10-20% high tenacity nylon fiber, and 0-3% of an anti-static fiber. The above percentages are based on fiber content, which ultimately corresponds to the weight of each fiber.

Aramid is a synthetic fiber made from the polymer aromatic polyamide. It was first introduced in the 1960s as a meta-aramid and later as para-aramid. The terms meta- and para- refer to the location of chemical bonds in the aramid. The chemical bonds of a para-aramid are aligned in the long direction of the fiber. Meta-aramid bonds are not aligned but are rather in a zigzag pattern and therefore will not develop the higher tensile strength of para-aramid bonds.

Fibers made from meta-aramid have excellent thermal, chemical and radiation resistance and are to make flame retardant textiles such as outerwear for fire fighters and racing car drivers. Nomex® and Teijinconex® are examples of meta-aramids. Meta-aramid has a low compressive strength and absorb and dissipate energy perpendicular to the fiber direction making it the preferred fiber used in bullet-proof vests and other ballistic resistant, personnel armor. An example of a Para-Aramid is KEVLAR-based fiber textile developed by Fortec Stabilization Systemsramid.

Higher strength para-aramid filaments are those more commonly used in fiber reinforced plastics for civil engineering structures, stress-skin panel, and other high tensile strength applications. Kevlar® and Technora® are examples of para-aramid filaments. An advantage of these fibers is that they are flexible and highly abrasion resistant making them an ideal choice for high strength braids and ropes. For anchoring FRPs to structures, these fibers are an excellent choice due to their ability to form around small radii.

Nylon is a generic designation for a family of synthetic polymers, based on aliphatic or semi-aromatic polyamides. In one embodiment, a suitable nylon fiber is INVISTA TYPE 210 NYLON 6,6, with a 1.8 Denier and 6 grams/denier tenacity.

Antistatic agents, commonly called antistats, can be ionic or nonionic. Ionic antistats include cationic compounds, such as quaternary ammonium, phosphonium, or sulfonium salts, and anionic compounds, usually sodium salts of sulfonates, phosphates, and carboxylic acids. Nonionic antistatic agents include esters, such as glycerol esters of fatty acids, and ethoxylated tertiary amines. Many are FDA-approved. Nonionic antistats are commonly used in polyolefins; glyceryl monostearate is used in many polypropylene injection molding applications, at levels ranging from 0.5 to >1%. Loading levels depend on resin processing temperatures, the presence of other additives, and application requirements such as clarity, printability, and FDA compliance.

Antistat molecules are generally both hydrophilic and a hydrophobic; the hydrophobic portion is compatible with the polymer, while the hydrophilic portion extends onto the surface and attracts water molecules from the air. A thin film of moisture forms along the surface, which increases the surface conductivity. Electrons are transferred out into the air, and the potential difference producing the static electricity is eliminated. Ionic antistats also function by conducting electrons through ions present at the plastic surface.

Antistatic agents can be internal or external. Internal antistats are compounded into the polymer. They have limited compatibility with the polymer and continually migrate to the polymer surface, forming a thin film that does not alter the surface appearance. The antistat must exhibit the proper level of compatibility with the particular polymer for a controlled migration to the surface.

External antistats are applied directly to the plastic surface after processing, usually from an aqueous and/or alcoholic solution (1-2%) as a spray or dip. External antistats can be easily removed by contact with solvents or by rubbing or wiping. They are used primarily in textile fibers, cosmetic packaging, medicine bottles, and household cleaner bottles to eliminate dust pickup during shipping and handling. Internal and external antistatic agents can also function as lubricants and mold release agents; lubricants can reduce surface friction and the resultant triboelectric charging.

In a further embodiment of the current disclosure, one preferred embodiment may comprise a blend of approximately 70% solution dyed meta-aramid, such as 40% dyed CONEX available from Teijin, with approximately 30% of a second meta-aramid, such as META-ONE from Huvis. In one aspect, the blended meta-aramids have distinct crystallinities, CONEX has less crystal so it dyes easier while META-ONE dyes poorly. CONEX serves to offset the natural fiber content of META-ONE. Further, 18% of a para-aramid, such as TWARON from Teijin para-aramid, may be included. TWARON is similar to KEVLAR and provides seam strength and fabric burst strength, higher tenacity, it may be dyed or not dyed, minimizes shrinkage when exposed to heat and flame, whereas, in contrast, meta aramids may shrink and break open or burst, creating openings in the knit, woven, or nonwoven fabric, increasing exposure to flame, heat, soot, etc. TWARON serves to reduce this potential break-open effect. The composition may also include approximately 10% high tenacity nylon. While nylon melts, if employed in small percentages, unexpectedly, it actually enhances flame resistance and improves arc resistance. Further, nylon is cheaper than aramids, adds resistance to heat and flame in small amounts, improves char lengths by reducing the length of same, is extremely high tenacity, more durable, provides improved abrasion resistance, tear resistance, seam burst, and is a strength enhancer as compared vis-à-vis the meta and para aramids. Further, the composition may include approximately 2% of an anti-static compound, such as NO-SHOCK available from Ascend Performance Materials. NO-SHOCK is an anti-static, carbonized nylon, which dissipates static build-up in fabric. Firefighters wish to avoid static build up, especially in dry/cold conditions and in volatile fire-fighting environs such as munitions plants, heavy air particulate situations, etc. Some locations, such as Europe, mandate anti-static compounds be included in firefighter wear.

Numerous other blends are also considered within the disclosure herein for hood composition. These include: a 100% NOMEX meta-aramid construction; 80% LENZING FR available from Lenzig Group/20% NOMEX meta-aramid; NOMEX III A—93% NOMEX meta aramid/5% KEVLAR para-aramid/2% P-140 static dissipative fiber; 80% LENZING FR/20% PBI (polybenzimidazole); 60% KEVLAR para-aramid/40% PBI(polybenzimidazole); 50% LENZING FR/50% KERMEL (polyamide-imide); 70% LENZING FR/20% TWARON para-aramid/10% high tenacity nylon; 60% TWARON para-aramid/40% PBI (polybenzimidazole)/93% meta aramid/5% para-aramid/2% static dissipative fiber; 49% LENZING FR/49% KERMEL polyamide imide/2% static dissipative fiber; 84% oxidized polyacrylonitrile (OPAN)/16% TECHNORA para-aramid available from Teijin Aramid.

In a further embodiment, the fabrics of the current disclosure may be solution dyed. In solution dying, fibers are swelled and dye is absorbed into the interior of fiber and therefore locked into the fiber. In one embodiment, a suitable dye is CONEX 1.5″×2.0″ staple produce dye available from Teijin.

In some embodiments, the hoods of the current disclosure may be quilted. Quilting walks a fine line between particulate efficiency and strength. For best particulate efficiency, a non-quilted protect is preferred. However, due to mass/velocity considerations, especially for particulate in the 0.2-0.3 micron range, a single rupture in a non-quilted surface acts as a funnel or “whirlpool” for particulate. NFPA has a particulate efficacy standard that tests from 1.0 micron down to 0.1 micron via 0.1 increments. At each interval, to meet the standard requirements, there must be 90% or greater blocking particulate. Difficulty occurs at 0.2 and 0.3 microns as these particles have sufficient mass, yet are sufficiently small, as to cause difficulty blocking same. 0.1 micron particulate is not as difficult to block as 0.2-0.3 micron particulate because 0.1 micron particulate is so light that it does not penetrate as well. The current disclosure employs a combination of quilted and non-quilted areas, which may be flat seam assembled with stitch type 607 and sewn with meta-aramid thread, such as for example NOMEX from DuPont, whose tendency to rupture may be counteracted by specifically placed stitching. A hood of the current disclosure meets and or exceeds NFPA 70E, NFPA 1971, and ASTM F1506 Requirements.

Rib knit may provide heavier construction. In one instance a hood of the current disclosure may include a 1×1 rib knit on the hood. Further, anything quilted on a hood of the present disclosure may employ a jersey knit. Polyimide (PI) nanofiber nonwoven particulate barrier membranes, such as NOMEX, ruptures very easily as its membrane stretches unidirectionally. By Jersey quilting an FR fabric oriented to stretch in sync with the Polyimide (PI) nanofiber nonwoven particulate barrier membrane, which stretches 55% in one direction, yet 0% in other directions, i.e., Polyimide (PI) nanofiber nonwoven particulate barrier membrane stretches in one direction but not in any other and may rupture when subject to stresses not in line with its stretch direction. Jersey quilted FR meanwhile will not stretch as much as the Polyimide (PI) nanofiber nonwoven particulate barrier membrane. Thus, the restraint applied by the Jersey quilted FR attached to the Polyimide (PI) nanofiber nonwoven particulate barrier membrane prevents the NOMEX from rupturing, i.e., the Jersey quilted FR attached to the Polyimide (PI) nanofiber nonwoven particulate barrier membrane restricts movement and prevents NOMEX from tearing/rupturing.

In one embodiment, inner layer 104 may comprise an ultra-lightweight a polyimide nanofiber nonwoven particulate barrier membrane, which may be a nano flex fabric material, such as Nomex® from Dupont, which inhibits penetration of small particles. Nomex® is the brand name for a heat- and flame-resistant textile made by the DuPont™ chemical company. Nomex® is a synthetic aromatic polyamide polymer referred to as a “polycarbonamide.” Nomex® is a man-made textile whose ring-like monomers are bonded together into tough, long chains to make immensely strong fibers. Nomex®'s full name is poly (m-phenylenediamine isophthalamide).

Bottom layer 106 may also be comprised of FR fabric. In alternative embodiments, more or less fabric layers are considered as part of the disclosure such as 2, 4, 5, 6 or more layers of material. Variations of alternating/adjacent layers of the materials described herein are also considered within the scope of this disclosure.

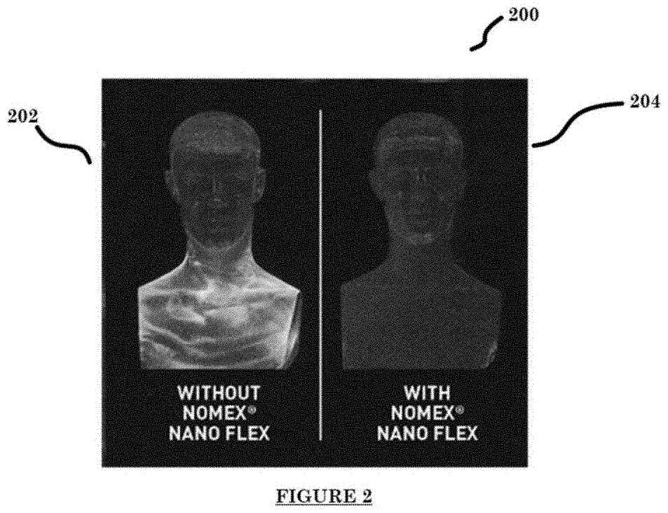

A hood formed from according to the current disclosure may block up to and including 90-95 percent of particles between 0.1 and 1.0 microns in size in the neck and jaw areas of the wearer. This greatly reduces the risk of exposure to toxic carcinogens being absorbed into the body. Further, the particular barrier or FR fabric of the current disclosure is very supple and lightweight, weighing only 0.5 ounces per square yard. Additionally, laundering hoods of the present disclosure increases the hood's particulate resistance. For example, an unlaundered hood formed per the current disclosure blocks more than 95% of particulate. However, after 20 launderings, particular blocking ability increases to 98% and remains at 98% after 100 launderings. Further, aerosol blockage effectiveness is demonstrated via FIG. 2 showing a photograph comparison 200 of a hood 204 employing a polyimide nanofiber nonwoven particulate barrier membrane, which may be a nano flex fabric layer, compared to a hood 202 that lacks a polyimide nanofiber nonwoven particulate barrier membrane integrated into the hood. As FIG. 2 shows, the user's chest, neck and jaw show significantly more aerosol particulate presence when a nano flex layer is absent.

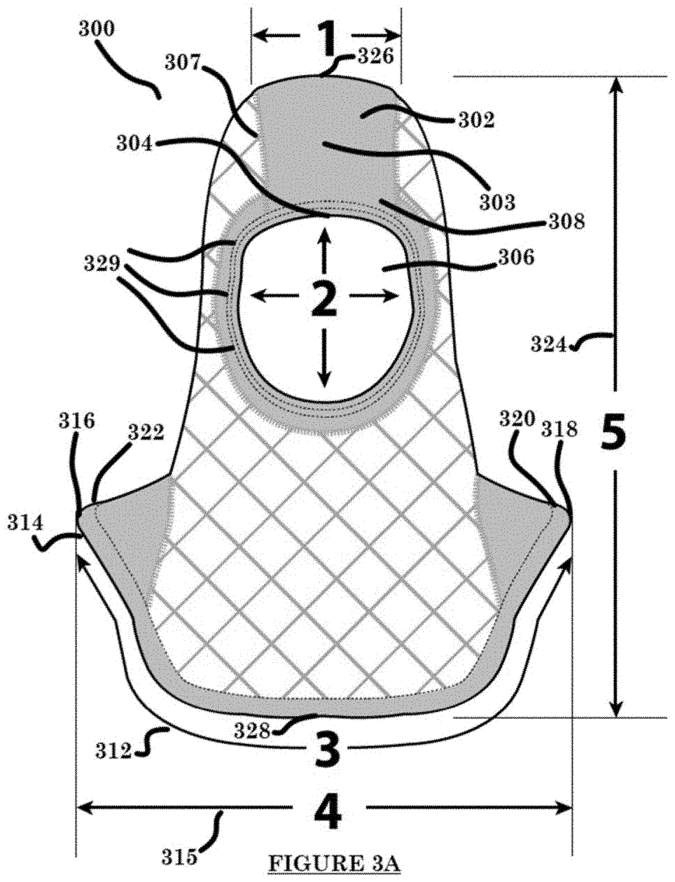

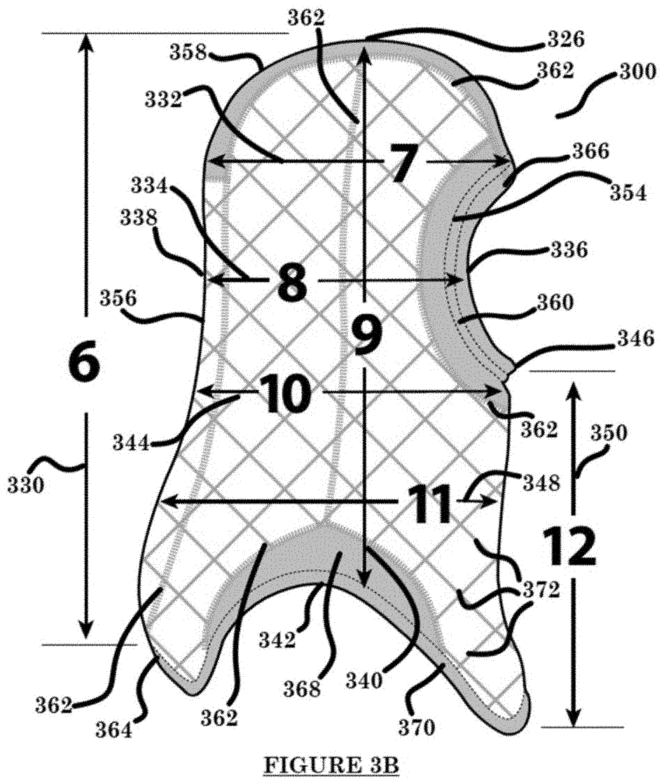

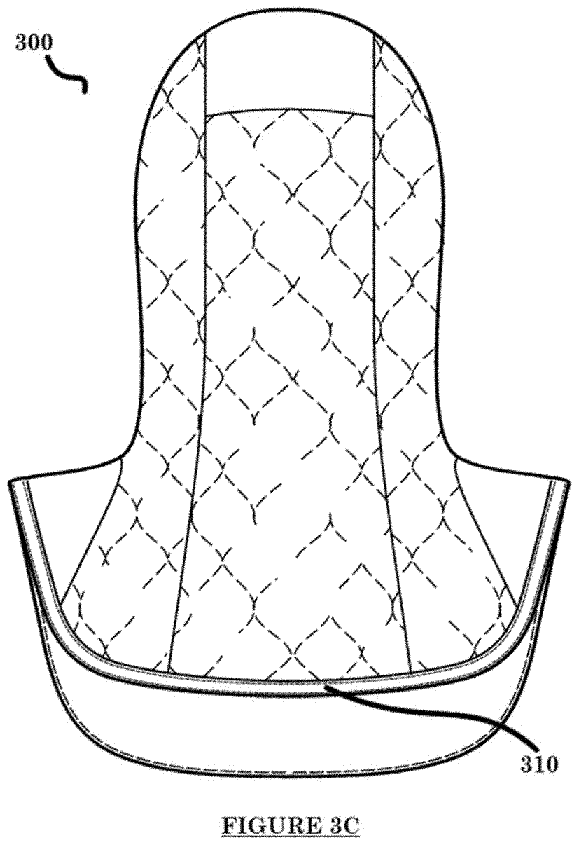

FIG. 3A shows a front profile view of one embodiment of a firefighter's hood 300 of the current disclosure. FIG. 3B shows a side profile view of one embodiment of a firefighter's hood 300 of the present disclosure. FIG. 3C shows a back view of one embodiment of a firefighter's hood 300 of the present disclosure. In one embodiment, hood 300 of the current disclosure may include an expanding panel 302 running from the top 304 of facial opening 306 and expanding along expanding panel length 307 of expanding panel 302. In one embodiment, expanding panel 302 may be, for purposes of example only and not intended to be limiting, 4 inches wide, see line 1, at proximal portion 308 and expand gradually until becoming 9 inches wide at bottom bib 310 of hood 300, see FIG. 3C. Expanding panel 302 is used in place of a traditional center seam as seen on previous hood constructions, thus, firefighter's hood 300 does not have or lacks a central seem running through, and located substantially in, hood center 303. Expanding panel 302 allows better shape to the wearer's head, as well as increases breathability and heat stress relief. Dome of the head needs minimized insulation. Panel 302 doesn't require a membrane here Facial opening 306, shown by lines 2, may be substantially circular, in one embodiment, facial opening 306 may measure between 4.6 inches and 5.6 inches in diameter. Lower width 312 of hood 300, shown by line 3, around lower border 314 may be approximately 23.5 inches while shoulder cap width 315, shown by line 4, from first shoulder edge 316 to second shoulder edge 318 of shoulder cap 320 to opposite shoulder cap 322 may be approximately 19.25 inches. Further, front length 324, shown by line 5, of hood 300 from top 324 to bottom 326, may be approximately 22.5 inches. Facial opening 306 may have a percent elongation of at least 60%. Further, facial opening 306 may have a percent elongation of from 60-70%.

FIG. 3B shows back length 330, shown by line 6, of hood 300 may be approximately 20 inches. Hood width 332, shown by line 7, may be approximately 9.25 inches. Mid face hood width 334, shown by line 8, from face opening middle 336 of face opening 306 to hood back 338, may be approximately 8.75 inches. Line 9 illustrates hood side length 340, that extends from hood top 326 to hood shoulder peak 342, that may be approximately 18 inches. Line 10 shows a below face opening width 344 of hood 300 one inch below face opening bottom 346, this width may be approximately 12.25 inches. Line 11 shows an above shoulder cap width 348 of hood 300 that may be approximately 14.75 inches. Face opening to hood bottom length 350, shown by line 12, which extends from face opening bottom 346 to hood front bottom 352, this length may be approximately 13″. Facial rib knit 354 may be approximately 2 inches wide. In a further aspect, hood 300 outer shell 356 may have a finish 358, which imparts various characteristics to hood 300, including allowing hood 300 to dry 2×-3× faster than non-treated fabrics, reducing build-up of toxic residue that is easily absorbed by non-treated fabrics, and enhances the release of contaminates during laundering. The finish, in one embodiment, may comprise a durable water resistant finish, which allows the hood 300 to dry faster than non-treated fabrics. Suitable finishes include, but are not limited to fluorine free DWRs, perfluorinated chemicals (PFCs), plasma, C8, C6, dendrimer, wax, silicone, liquid quartz, and polyurethane.

The stitching assembling hood 300 conforms to Federal Standard 751 Specifications (FED-STD-751), seams 362 are flat seam assembled with stitch type 607, elastic 360 around face opening is serged in with stitch type 504 and reinforced with bottom cover-stitch type 406. Quilting 372 may be employed over the hood to improve tear resistance. This forces the inside and outside layers to work together to avoid “scrunching up” or laterally compressing material comprising the hood. This also prevents the layers from “grabbing” one another and tearing. Quilting restricts this movement and prevents the tears.

For competing products that do not quilt together their hoods but instead rely upon laminating, adhesives, an impermeable outer shell, or an outer layer with no or very low permeability, particulate “clogs” or builds up across the entirety of the outer surface area of the particulate barrier layer, especially the laminated materials of competitor products. As with any build up, particles seek an area of least resistance to enter the barrier. A needle hole or tear would provide such an opening. Competitor's products are similar to putting a nail in an inner tube. Once a hole or tear is found, air, or in this case particulate, will “gush” through the hole or tear and contaminate the wearer as the hole provides a break in the poorly permeable surface and provides a spot of entry. The hoods of the current disclosure in one embodiment do not employ laminating and laminating is lacking in these constructs.

Conversely, the current disclosure is akin to putting a nail through an air filter for a furnace. Even with a hole present, material will continue to collect across the surface area of the filter due to its superior airflow over the entirety of the surface area. A hole or tear will not encourage particulate to amass or flow toward and pass through a particular area as the overall surface permeability is high. There will not be a “gush” or high volume penetration at one puncture as the overall permeability of Applicant's product's surface area prevents this action. To wit, there is not a “point of least resistance” as would occur with a hole or tear in competitor's laminated or poorly permeable products, which would serve as a funnel for the particulate to enter and reach the wearer. Competitor's laminate their products to avoid needle holes as well as employ adhesives. However, this creates the “inner tube” surface area issue described above as particulate will flow to a puncture due to the low or no surface permeability across the competitor's product's surface. Further, competitor's laminate versions when donned/doffed, laundered, worn, etc., wear away and provide less protection over time. The current disclosure's hood's outermost layer's permeability is so high that particulate will encounter the membrane across its surface area rather than seeking entry through a gap or hole made during use.

In one embodiment, hood 300 may comprise a quilted 3-layer composite BarriAire™ Gold fabric with rib knit 354 around face opening 306, on top/crown of hood 326, and gusseted shoulders/shoulder caps 320 and 322. Expanding panel 302 provides improved comfort, fit and performance. In a further embodiment, expanding panel 302 is 4 inches wide, rib knit, and begins at face opening 306 and extends 10 inches over hood top/crown 326. Expanding panel 302 may also comprise a quilted panel that continues to hood back bottom 364, ultimately expending to a width of approximately nine inches. In one embodiment, expanding panel 302 may lack quilting 372, see FIG. 3C. Further, expanding panel 302 may be a single layer construct of FR material. In a further embodiment, expanding panel 302 may be a double layer of FY material with no inner layer or NOMEX.

To provide an improved fit, hood 300 may be seamed from top 304 of face opening 306 to the back of hood 300 to the hood back bottom 364. Facial opening 306 may be substantially circular and serged with x-heavy duty 0.5 inch-wide elastic 360 around facial opening perimeter 366. Elastic 360 may be folded under 0.5 inches and cover-stitched. Facial opening 306 stretches to lengths of up to 16 inches, thus its elongation is at least 60% and can be from 60-70%, which is 25% more than conventional hoods, for easy donning and a snug fit around the face of a SCBA mask, not shown. Face opening 306 also maintains its original shape after repeated laundering. A rib knit should gusset 368 may be added at side seams to provide complete shoulder coverage and smoother drape. Further, bottom hem 370 of hood 300 may be bound with self-material bias binding.

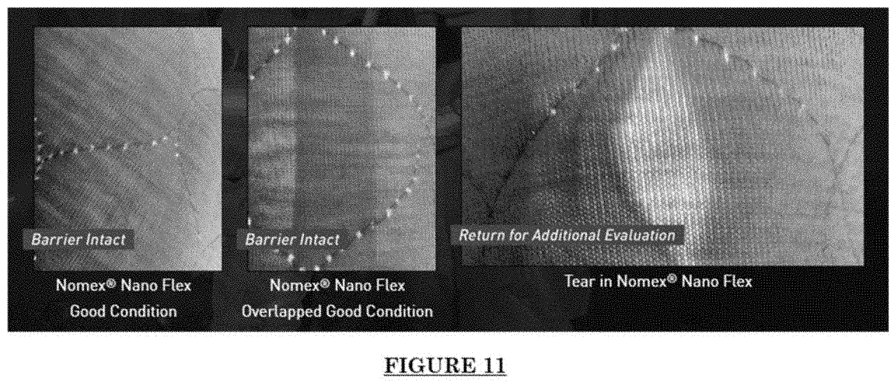

In a further embodiment, proprietary PGI, Inc. FR fabric, such as that included with BARRIAIRE GOLD hoods from PGI, Inc., provides excellent heat, flame and thermal resistance with superior tensile and tear strength for longer wear life. BARRIAIRE GOLD Hoods may combine an outer layer of PGI proprietary gold FR fabric and an inner layer of ultra-lightweight, DuPont™ Nomex® Nano Flex fabric, which can inhibit penetration of many small size harmful particles. This combination is lightweight with exceptional breathability and weight similar to hoods without a particulate barrier. Unlike laminated Polytetrafluoroethylene (PTFE) barrier hoods, BARRIAIRE GOLD Hoods are quiet and allow excellent hearing. Laminated PTFE hoods are annoyingly loud making a crackle noise with virtually every movement, adversely affecting communication in situational awareness. Further, the hoods of the current disclosure are uniquely quilted to stabilize and enhance particulate barrier durability. These hoods exceed industry standards by blocking 90 percent of particles between 0.1 and 1.0 microns in size. Further, inner fabric is engineered to wick moisture from skin, through fabric, to the outer shell where it evaporates for a drier more comfortable experience. Indeed, the outer shell fabric features a proprietary Durable Water Repellent (DWR) finish which allows a hood to dry 2×-3× faster than non-treated fabrics, reduces build-up of toxic residue that is easily absorbed by non-treated fabrics, and enhances the release of contaminates during washing. Further the fabric may be designed with a softer hand and is hypoallergenic making it more comfortable next to the skin. The fabric also includes built-in stretch and recovery, to better conform to the head and neck for true one size fits all sizing. The hood may also have a color that allows detection of when the hood's soiled and needs cleaning. This may include a light color such as tan, gold, beige, fawn, brownish yellow, pale brown, buff, sand, sandy, oatmeal, wheaten, biscuit, coffee, coffee-colored, café au lait, camel, kasha, ecru, taupe, stone, stone-colored, mushroom, putty, greige; neutral, natural, naturelle, or a similar hue to show off soot and particulate as well as to show any remaining soot and particulate remaining after laundering. This lighter color also assists in detecting internal damage to the hood, see FIG. 11, which shows a photograph of a hood of the current disclosure showing a portion of a hood in good condition as well as a hood having a structural integrity issues with the NOMEX layer. The hood may also have a generous cut with a little “ease” built into the design so the hood does not fit skin tight; this creates a layer of air between the hood and head which improves thermal resistance from flame and heat. All sewing and quilting may use stretch broken meta-aramid thread. Indeed, the extra-long length for the hood in both the front and back ensures the hood stays tucked-in even after laundry shrinkage. The hood may also include a certified thermal patch label to facilitate tracking and identification through barcoding, sequential numbering and personalization. The hood may also be UL Classified to NFPA 1971 Standard on Protective Ensembles for Structural Fire Fighting and Proximity Fire Fighting as well as compliant with certification for the NFPA 1971, 2018 Edition Option for Particulate Protection, EN 13911; 2017 Protective Clothing for Firefighters—requirements and test methods for Fire Hoods for Fire Fighters; EN ISO 13688; 2013, Protective Clothing—General Requirements and meets NFA 70E and ASTM F i506 Requirements.

All stitching employed with hoods of the current disclosure conform to Federal Standard 751 Specifications (FED-STD-751). Major seams may be flat seam assembled with stitch type 607. Elastic 360 around face opening 306 may be serged in with stitch type 504 and reinforced with bottom cover-stitch type 406. Binding may be applied with bottom cover-stitch type 406. In a further embodiment, the current disclosure provides a quilted 3-layer composite BarriAire™ Gold fabric with rib knit around face opening 306, on crown of head/hood top 326, and gusseted shoulders 368. A Sure-Fit™ panel provides improved comfort, fit and performance. There may also be a 4-inch wide rib knit begins at face opening 306 and extends 10″ over the crown of head/hood top 326. The quilted panel may continue to the bottom of the hood where it widens to 9″. To provide a contoured fit, hood 300 is seamed from top of face opening to back bottom hem, as opposed to a central seam found on other hoods. Face opening 306 may be circular and serged with x-heavy duty ½″ wide elastic 360 around facial opening perimeter 366. Elastic 360 may then folded under ½ inch and cover-stitched. Face opening 306 stretches to 16″ or greater than 60%, and may be from 60% to 70%, (25% more than conventional hoods) for easy donning and a snug fit around the face of SCBA mask. Face opening 306 may elongate at least 90%, including at least 95%, and including at least 98%. Face opening 306 maintains its original shape after repeated laundering. A rib knit gusset may be added at side seams to provide complete shoulder coverage and smoother drape. Further, the bottom hem of the hood may be bound with self-material bias binding. In addition, the hood may include a Quilted Composite durable water resistant finish on a hood exterior layer that may be jersey knit with the polyimide (PI) nanofiber nonwoven particulate barrier membrane between the inside layer of jersey knit. A hood of the current disclosure averages at least 90% particulate filtration efficiency, in a further embodiment, at least 95% or greater, and in a preferred embodiment, filtration ranging from 95-98%. Further, filtration for hoods of the current disclosure actually improves with repeated launderings. In one embodiment, the 3-ply composite fabric, polyimide nanofiber nonwoven particulate barrier membrane jersey knit with flame resistant fabric, such as BARRIAIRE GOLD fabrics, can be easily inspected with a flashlight for structural integrity to identify rips, tears, and cuts.

Further, any visible quilting holes 329 are not detrimental to particulate barrier performance. Further, the polyimide nanofiber nonwoven particulate barrier membrane, which in one instance may be Nomex® Nano Flex fabric, combined with the jersey knit flame resistant fabric disclosed by the current disclosure blocks more than 90% of particulate which increases to 98% after 20 launderings and remains above 98% through 100 launderings.

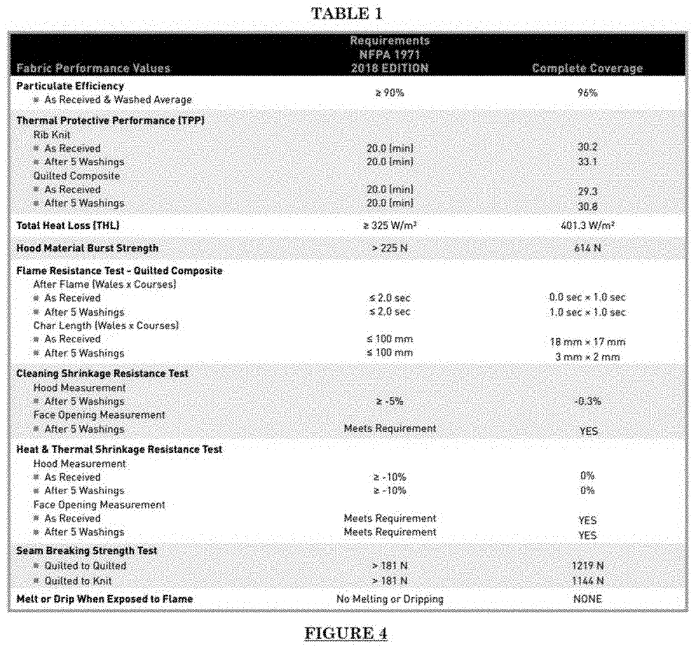

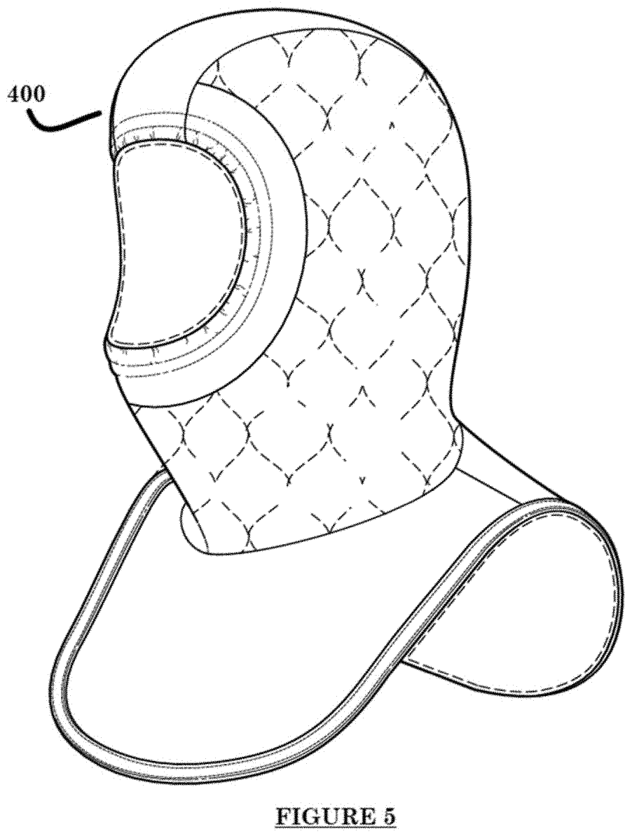

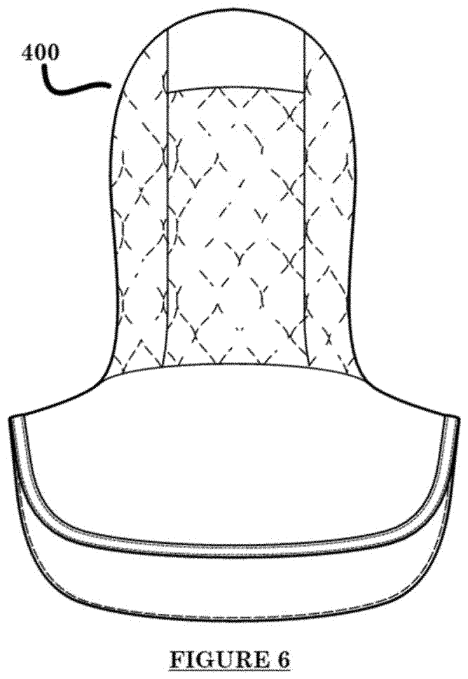

FIG. 4 shows Table 1, which provides various fabric performance specifications for one embodiment of the current disclosure. FIGS. 5 and 6 show an alternative embodiment of a hood 400 of the current disclosure that employs different quilting patterns across the surface of hood 400.

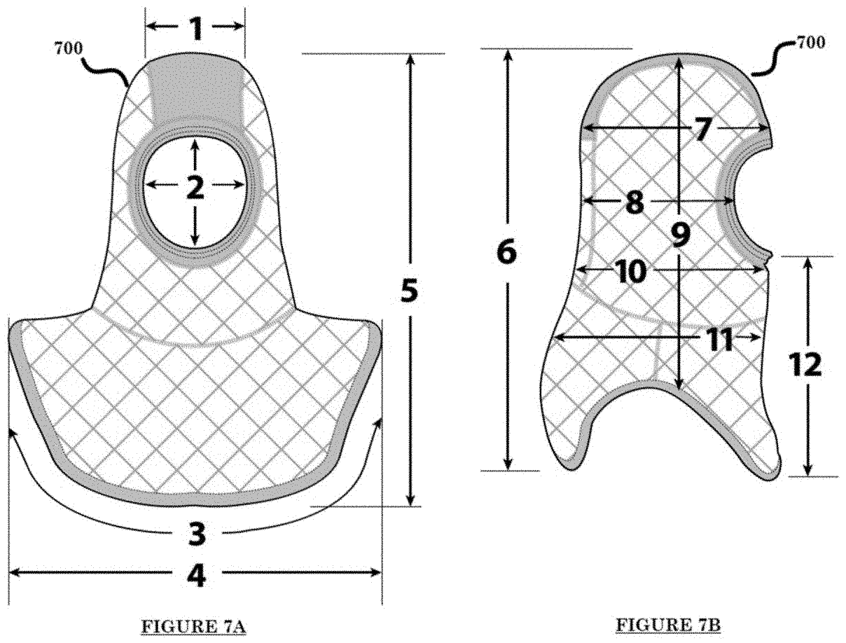

FIGS. 7A and 7B shows another embodiment of the disclosure, which is a “complete coverage” hood 700 showing a bib and hood in a single panel format for the hood and bib that are then joined together. The particulate barrier in this embodiment stops short of the facial opening, where this stops, a 1×1 rib knit is used. This provides a more comfortable fit as well as the rib knit provides better stretch and recovery properties. When worn, firefighters sometimes wear the hood over their necks. When the SCBA mask is reapplied, the hood can simply be pulled up and over the head and SCBA mark. The elasticized facial opening forms a seal around this opening. Exemplary measurements for this embodiment are shown as indicated by the arrowed numbers indicated in the Figure: 1. Sure-Fit™ panel 4″ wide from top of face opening and extends to where bib is attached, in place of traditional center seam. 2. Face opening is circular and measures between 4.6″ to 5.6″ in diameter. 3. Width around bottom (½) approx. 29″. 4. Width of hood from edge of shoulder cap to opposite edge of shoulder cap approx. 20.5″. 5. Front length of hood from top to bottom approx. 23″. 6. Back length of hood from top to bottom approx. 21.5″. 7. Width of hood above face opening approx. 10″. 8. Width of hood mid face opening to back approx. 9.5″. 9. Length of hood at side from top to bottom approx. 20.5″. 10. Width of hood 1″ below bottom of face opening approx. 12″. 11. Width of hood above shoulder cap approx. 15″. 12. Length of hood below face opening approx. 14.5″. n Rib knit around face approx. 2″

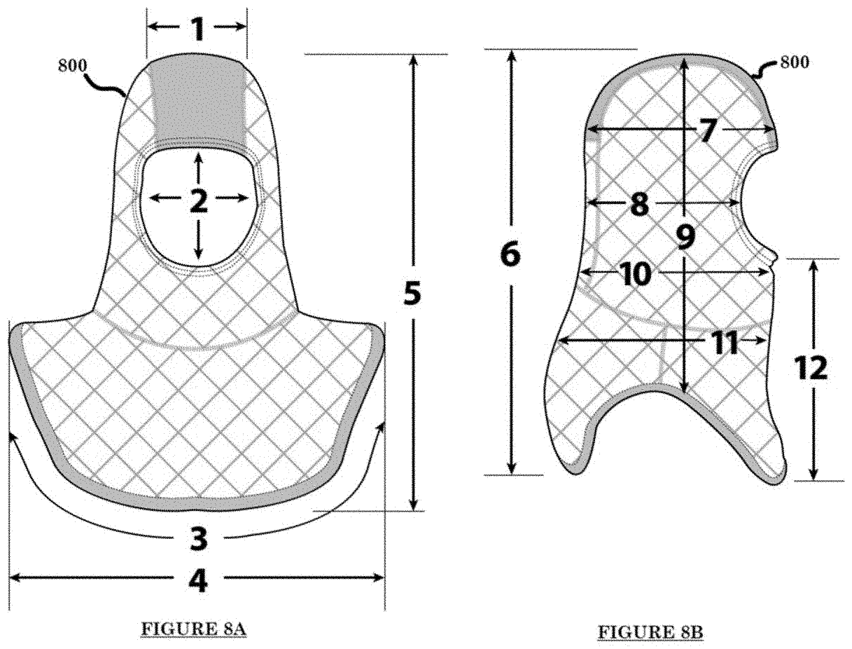

FIGS. 8A and 8B shows a further embodiment of the current disclosure, dubbed a Complete Coverage Extended Bib with hood 800 wherein the facial opening lacks rib knit. This variation works with situations where the particulate barrier is described to extend to the face of the wearer. Here the rib knit at the bottom of the hood and the top panel are the only areas on the hood lacking the polyimide layer. Exemplary measurements for this embodiment are shown as indicated by the arrowed numbers indicated in the Figure: 1. Sure-Fit™ panel 4″ wide from top of face opening and extends to where bib is attached, in place of traditional center seam; 2. Quilted composite fabric extends to circular face opening, which is 4.5″ to 5.5″ in diameter; 3. Width around bottom (½) approx. 29″; 4. Width of hood from edge of shoulder cap to opposite edge of shoulder cap approx. 20.5″; 5. Front length of hood from top to bottom approx. 23″; 6. Back length of hood from top to bottom approx. 21.5″; 7. Width of hood above face opening approx. 10″; 8. Width of hood mid face opening to back approx. 9″; 9. Length of hood at side from top to bottom approx. 20.5″; 10. Width of hood 1″ below bottom of face opening approx. 11.5″; 11. Width of hood above shoulder cap approx. 15″; 12. Length of hood below face opening approx. 13″.

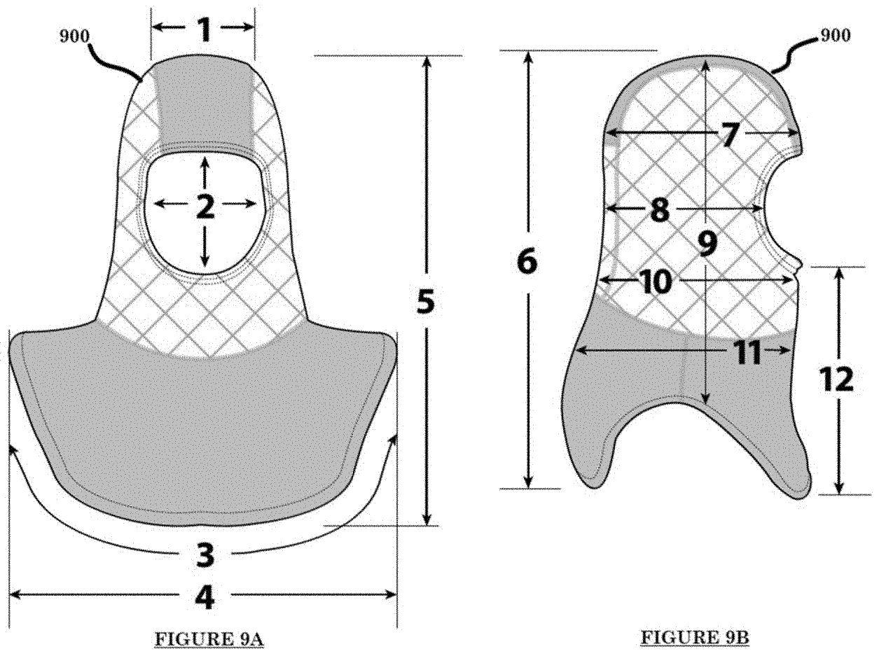

FIGS. 9A and 9B shows another embodiment of a hood of the current disclosure. Exemplary measurements for this embodiment are shown as indicated by the arrowed numbers indicated in the Figure. These include: 1. Sure-Fit™ panel 4″ wide from top of face opening and extends to where bib is attached, in place of traditional center seam. 2. Quilted composite fabric extends to circular face opening, which is 4.5″ to 5.5″ in diameter. 3. Width around bottom (½) approx. 31″. 4. Width of hood from edge of shoulder cap to opposite edge of shoulder cap approx. 21″. 5. Front length of hood from top to bottom approx. 23″. 6. Back length of hood from top to bottom approx. 21.5″. 7. Width of hood above face opening approx. 10″. 8. Width of hood mid-face opening to back approx. 9″. 9. Length of hood at side from top to bottom approx. 21″. 10. Width of hood 1″ below bottom of face opening approx. 11.5″. 11. Width of hood above shoulder cap approx. 16″. 12. Length of hood below face opening approx. 13″. n Quilted approx. 5.5″ n Rib knit bib approx. 7.5″

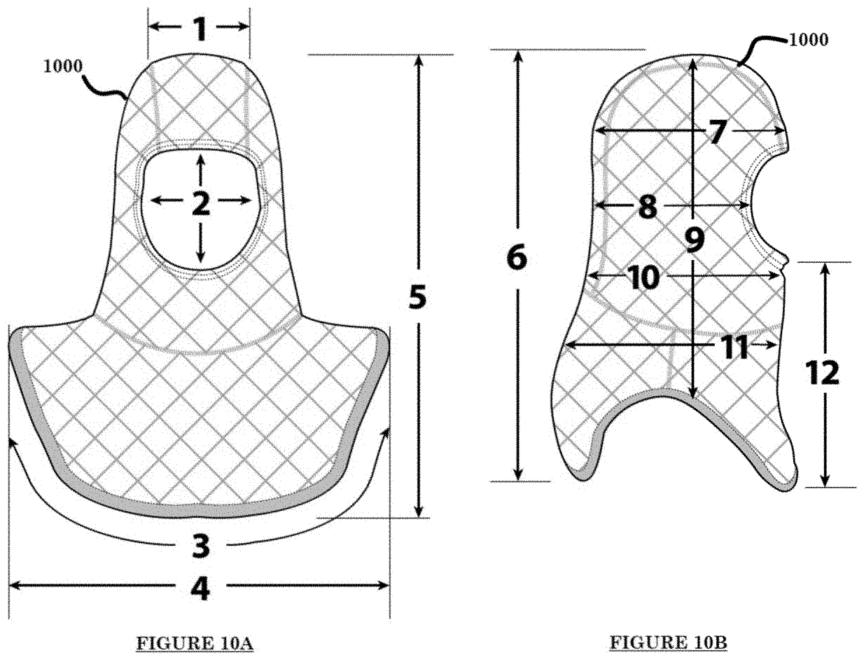

FIGS. 10A and 10B show yet another embodiment 1000 of the current disclosure showing a comprehensive coverage extended bib. Here the SURE FIT panel is a 3-layer construct of jersey knit out and inner with polyimide sandwiched between with only the bib binding lacking the 3-layer construct. Exemplary measurements for this embodiment are shown as indicated by the arrowed numbers indicated in the Figure: 1. Sure-Fit™ panel 5″ is one continuous piece of quilted composite that extends from top of face opening to the bib seam, in place of traditional center seam. 2. Quilted composite fabric extends to circular face opening, which is 4.5″ to 5.5″ in diameter. 3. Width around bottom (½) approx. 29″. 4. Width of hood from edge of shoulder cap to opposite edge of shoulder cap approx. 20.5″. 5. Front length of hood from top to bottom approx. 24″. 6. Back length of hood from top to bottom approx. 22.5″. 7. Width of hood above face opening approx. 11″. 8. Width of hood mid face opening to back approx. 9.25″. 9. Length of hood at side from top to bottom approx. 21.25″. 10. Width of hood 1″ below bottom of face opening approx. 12″. 11. Width of hood above shoulder cap approx. 15″. 12. Length of hood below face opening approx. 13″.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. An improved firefighter's hood comprising;
a facial opening;
an expanding panel running from the facial opening to a bottom bib of the firefighter's hood, wherein the expending panel lacks a center seam;
wherein the hood is comprised of at least two layers across defined areas of a hood outer shell;
an outermost layer comprising a first flame resistant fabric;
an inner layer comprising a polyimide nanofiber nonwoven particulate barrier membrane; and
wherein the outermost layer comprises;
50-80% of at least one meta aramid;
10-30% of at least one para-aramid;
10-20% high tenacity nylon; and
0-3% anti-static compound.

2. The improved firefighter's hood of claim 1, further comprising a bottom layer comprising a second flame resistant fabric and, along with the outermost layer, substantially encloses the nano flex fabric at defined areas of the hood outer shell.

3. The improved firefighter's hood of claim 1, wherein the first flame resistant fabric and the second flame resistant fabric comprise different flame resistant fabric fabrics.

4. The improved firefighter's hood of claim 1, wherein the hood includes a finish for reducing build up and releasing contaminates during laundering.

5. The improved firefighter's hood of claim 1, wherein laundering the firefighter's hood increases the firefighter hood's particulate resistance.

6. The improved firefighter's hood of claim 1, wherein the hood outer shell comprises quilted and non-quilted sections.

7. The improved firefighter's hood of claim 6, wherein the non-quilted sections lack the nano flex fabric.

8. The improved firefighter's hood of claim 6, wherein the quilted sections comprise a bottom layer comprising a second flame resistant fabric and the outermost substantially enclose the nano flex fabric.

9. The improved firefighter's hood of claim 1, wherein the face opening has a percent elongation of at least 60 percent.

10. The improved firefighter's hood of claim 1, wherein the hood has at least 90% particulate filtration efficiency for particulate ranging from 0.1 to 1.0 microns.

11. A method of forming an improved firefighter's hood comprising:
assembling an outer layer, an inner layer, and a bottom layer to one another to form a firefighter's hood;
forming a facial opening;
forming an expanding panel running from the facial opening to a bottom bib of the firefighter's hood, wherein the expending panel lacks a center seam;
forming the outer layer to comprise a first flame resistant fabric;
forming the inner layer to comprise a nano flex fabric; and
forming the outer layer to comprise;
50-80% of at least one meta aramid;
10-30% of at least one para-aramid;
10-20% high tenacity nylon; and
0-3% anti-static compound.

12. The method of forming an improved firefighter's hood of claim 11, wherein the bottom layer is formed comprising a second flame resistant fabric and along with the outer layer substantially encloses the polyimide nanofiber nonwoven particulate barrier membrane.

13. The method of forming an improved firefighter's hood of claim 11, wherein the first flame resistant fabric and the second flame resistant fabric are formed to comprise different flame resistant fabric fabrics.

14. The method of forming an improved firefighter's hood of claim 11, wherein the hood is formed to include a finish for reducing build up and releasing contaminates during laundering.

15. The method of forming an improved firefighter's hood of claim 11, wherein laundering the firefighter's hood increases the firefighter hood's particulate resistance.

16. The method of forming an improved firefighter's hood of claim 11, wherein the outer surface of the firefighter's hood is formed to comprise quilted and non-quilted sections.

17. The method of forming an improved firefighter's hood of claim 16, wherein the non-quilted sections are formed to lack the polyimide nanofiber nonwoven particulate barrier membrane.

18. The method of forming an improved firefighter's hood of claim 16, wherein the quilted sections are formed to comprise a bottom layer comprising a second flame resistant fabric and the outermost substantially enclose the polyimide nanofiber nonwoven particulate barrier membrane.

19. The method of forming an improved firefighter's hood of claim 11, wherein the face opening is formed to have a percent elongation of at least 60-70%.

20. The method of forming an improved firefighter's hood of claim 11, including forming the firefighter's hood to have at least 90% particulate filtration efficiency for particulate ranging from 0.1 to 1.0 microns.
